(19) United States
(12) Patent Application Publication
(10) Pub. No.: US 2010/0017801 A1
(43) Pub. Date: Jan. 21, 2010

(54) PROFILE BASED CREATION OF VIRTUAL MACHINES IN A VIRTUALIZATION ENVIRONMENT

(75) Inventor: Krishnamurthy KUNDAPUR, Bangalore (IN)

Correspondence Address: VMWARE, INC., DARRYL SMITH, 3401 Hillview Ave., PALO ALTO, CA, 94304, US

(73) Assignee: VMWARE, INC., Palo Alto, CA (US)

(21) Appl. No.: 12/176,251

(22) Filed: Jul. 18, 2008

(51) Int. Cl. G06F 9/455

(52) U.S. Cl. 718/1

(57) ABSTRACT

A method of creating a new virtual machine in a hypervisor server using a virtual machine setup profile is disclosed. A virtual machine setup profile method is selected from a plurality of virtual machine setup profiles. Then, system information is retrieved from the hypervisor server. The system information includes available computing resources in the hypervisor server. Thereafter a number of virtual machines that can be hosted in the hypervisor server based on the available computing resources is calculated and a number of new virtual machines are created in the hypervisor server.

### BACKGROUND

Virtual Machines (VMs) in a physical system are created manually after installing a hypervisor on a server computer. In big data centers, this task of creating hundreds of the VMs could be enormously time consuming. Moreover, the server computing resources are not optimally utilized because the person creating these VMs may not fully appreciate the availability of the computing resources to their fullest extent.

### SUMMARY

In one embodiment, a method of creating a new virtual machine in a hypervisor server using a virtual machine setup profile is disclosed. A virtual machine setup profile method is selected from a plurality of virtual machine setup profiles. Then, system information is retrieved from the hypervisor server. The system information includes available computing resources in the hypervisor server. Thereafter a number of virtual machines that can be hosted in the hypervisor server based on the available computing resources is calculated and equal number of new virtual machines are created in the hypervisor server.

In another embodiment, a method of creating a new virtual machine in a hypervisor server is disclosed. The method includes (a) selecting a virtual machine setup profile from a plurality of virtual machine setup profiles, and (b) retrieving a system information from the hypervisor server. The system information includes available computing resources in the hypervisor server. The method further includes (c) determining if the available computing resources are sufficient to host the new virtual machine, and (d) calculating if the available computing resources are sufficient to host the new virtual machine, if the available resources are sufficient, creating a new virtual machine based on the virtual machine setup profile. Then steps (b) to (d) are repeated until the available computing resources become insufficient to host the new virtual machine based on the virtual machine setup profile.

In yet another embodiment, a computer readable media to store programming instructions for creating a new virtual machine in a hypervisor server is disclosed. The computer readable media includes programming instructions for (a) selecting a virtual machine setup profile from a plurality of virtual machine setup profiles, and programming instructions for (b) retrieving system information from the hypervisor server, wherein the system information includes available computing resources in the hypervisor server. The computer readable media also includes programming instructions for (c) determining if the available computing resources are sufficient to host the new virtual machine, and programming instructions for determining (d) if the available computing resources are sufficient to host the new virtual machine, and if the available computing resources are sufficient, creating a new virtual machine based on the virtual machine setup profile. Still further, the computer readable media includes programming instructions for repeating steps (b) to (d) until the available computing resources become insufficient to host the new virtual machine based on the virtual machine setup profile.

In yet another embodiment, a system for crating a virtual blade server is disclosed. The system includes a virtual machine (VM) pool information collector to retrieve a list of virtual machines from a hypervisor server and a VM pool information storage in communication with the VM pool information collector to store the list of virtual machines. The system also includes a Web server in communication with the VM pool information storage to host an application to display the list of virtual machines, wherein the application enables selection of a VM from the list of virtual machines to reserve the VM for a specific use.

### BRIEF DESCRIPTION OF THE DRAWINGS

FIG. 1 illustrates a hypervisor server in communication with a profile data store in accordance with one or more embodiments of the present invention.

FIG. 2 illustrates an exemplary VM setup profile in accordance with one or more embodiments of the present invention.

FIG. 3A illustrates an exemplary user interface to start a selected method of creation of the VMs in accordance with one or more embodiments of the present invention.

FIG. 3B illustrates a flow diagram of setting up virtual machines in a newly installed hypervisor server in accordance with one or more embodiments of the present invention.

FIG. 4 illustrates a flow diagram of setting up virtual machines based on a profile and the system capabilities in accordance with one or more embodiments of the present invention.

FIG. 5 illustrates a flow diagram of setting up virtual machines based on iterative queries for the system information in accordance with one or more embodiments of the present invention.

### DETAILED DESCRIPTION

Embodiments of the present invention describe automatic creation of virtual machines (VMs) in hypervisor servers using VM setup profiles. In one or more embodiments, a VM setup profile includes hardware information such as a type of processor, a physical memory, a network speed or bandwidth, etc. In one embodiment, a VM setup profile may include number of virtual machines that should be created in a particular type of a hypervisor server. In other embodiments, a creation of the VMs can be based on available resources in a hypervisor server. For example, the availability of resources, such as a CPU use, a network use, a memory use, etc. is monitored and if these parameters are less than predefined values, virtual machines are created recursively until these computing resources fall within a predefined range.

Before virtual machines are created, a virtualization software, e.g., a hypervisor (example—VMware ESX Server™) is installed on a bare metal computer system. A bare metal computer system is a computer system on which a general purpose operating system (such as Microsoft Windows™ or Linux™) has not yet been installed.

In another embodiment, a general purpose operating system is first installed on a bare metal computer system and then a virtualization software is installed. This configuration is generally referred to as a hosted virtualization environment. One or more embodiments of the present invention can be used in both of the above configurations.

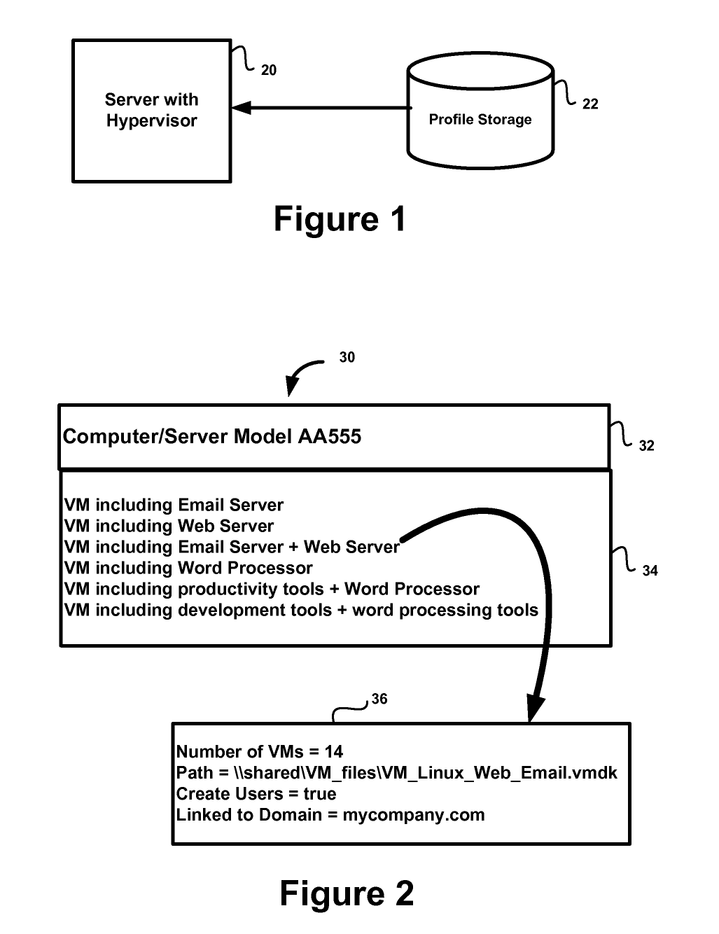

FIG. 1 illustrates a server computer 20 on which a hypervisor (e.g., VMware ESX Server™) has been installed. Server 20 is in communication with a profile storage 22. In one embodiment, profile storage 22 is located on server 20 itself. In other embodiments, profile storage 22 is located on any computer in a network. In yet another embodiment, profile storage 22 can be in communication with server 20 via the Internet. In one embodiment, profile storage 22 is centrally located and accessible to a plurality of hypervisor servers in the local area network.

Profile storage 22 stores a plurality of virtual machine (VM) setup profiles. VMs are created on a hypervisor server to provide a virtualization environment. Terms virtualization and virtual machines are well known in the art, hence, their descriptions are being omitted.

FIG. 2 illustrates an exemplary VM setup profile 30. In one of more embodiments, VM setup profile 30 includes a description 32 of a server including the computing capabilities of server 20. For example, description 32 may include a system configuration such as a type of processor (CPU), required random access memory (RAM) or a physical memory, disk memory, data communication speed, data storage capacity, processor power, etc. A VM setup profile also includes one or more selectable VM types 34. In one example, a VM type 34 includes the name of an operating system and a list of preinstalled applications (including Email servers, Web servers, Enterprise Resource Planning applications, etc.). In one or more embodiments, each of the plurality of VM setup profiles includes requirements for one or more of a random access memory (RAM), a hard disk space, and a processor power. For example, VM type 34 “VM Linux with Email Server” points to a VM that includes the Linux T operating system and an Email Server preinstalled on this operating system environment. Profile storage 22 also includes details 36 of each of the plurality of VM setup profiles. These details include a name and a path of a VM file that will be used to setup a VM of a selected type. The VM file may be stored anywhere in a computer network so long as this file is accessible for reading from server 20. Further, in one or more embodiments, a VM setup profile also includes an initial number of VMs to be created when a particular VM profile is selected for the VM setup. This initial number of VMs generally related to the system configuration of server 20. For example, a setup profile for a high end server may include a higher number of initial VMs and vice versa.

In one or more embodiments, after a hypervisor software is installed on server 20, a user interface is displayed to enable selection of a particular VM type to be created. In one or more environment, more than one types of VMs may be selected to be created. Once a VM type is selected, the selected type of VMs are created in server 20.

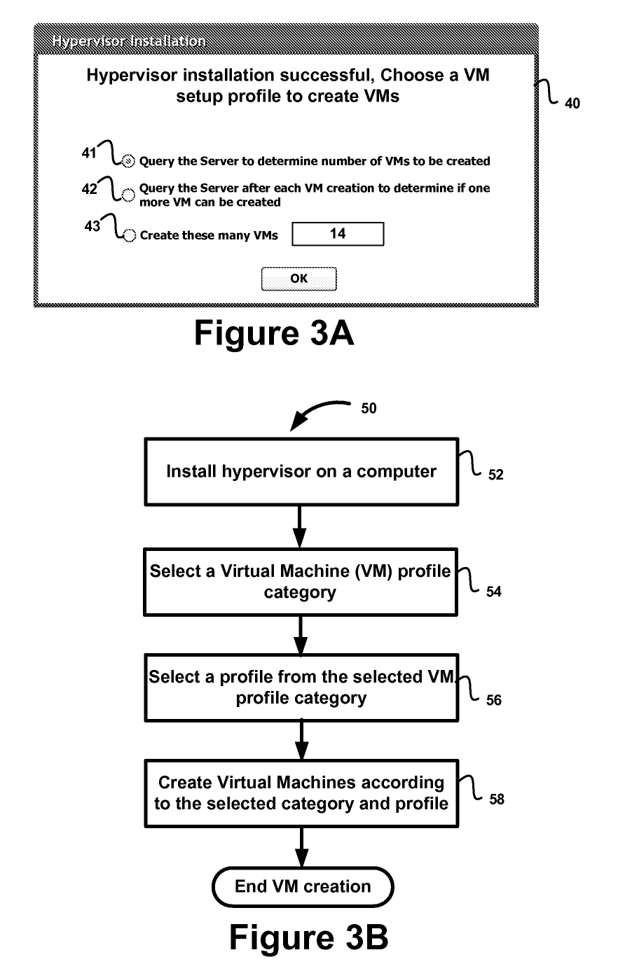

FIG. 3A illustrates an exemplary user interface (UI) 40 to collect user input regarding creating of the VMs. However, in other embodiment, this step may be skipped by using scripting of commands and running the scripting in an unattended mode. A particular selection as to how the VMs would be created is entered into a script based on a server specification. In one or more embodiments, UI 40 is displayed to a server administrator/user after a virtualization software is installed on server 20. In one embodiment, a VM setup profile is selected before displaying UI 40. If option 41 is selected, server 20 is queried once to determine how many VMs of a selected type (from list 34 in FIG. 2) can be created. If option 42 is selected, server 20 is queried after creation of each VM to determine if enough resources are available to create one more VM of a selected type. Alternatively, option 43 can be selected to manually enter a number of VMs that should be created. This number can be based upon prior experience of setting up VMs on a server similar to server 20.

FIG. 3B illustrates a flow diagram 50 of creating a number of VMs of a particular type in a hypervisor server. At step 52, a hypervisor software is installed on a server. At step 54, a user interface is displayed to enable selection of a VM profile category. The VM profile category, in one or more embodiment, includes a server configuration identification of a server. For example, a listing of VM profile categories may include a category with description “Model AT500, a dual core processor with 4 GB RAM”. Based on the system configuration of a server, an appropriate category is selected. In another embodiment, this category is automatically selected based on a match of the system configuration with data includes in one or more VM setup profiles. Further, in one or more embodiment, a scripting may be utilized to replace manual selection of a VM profile category. In one or more embodiments, a category selection is used to decide how many VMs can initially be created on the server, based on the system configuration of the server.

At step 56, a VM setup profile is selected either via a user interface or by executing an automation script. For example, if the server is being setup to host an Email server, a particular VM profile that includes an Email server software is selected automatically via a script. At step 58, a particular number of VMs are created in the server based on a selection of a particular VM profile category and a particular VM profile selection. A typical hypervisor server provides an application programming interface (API) to create VMs therein. As mentioned earlier, a VM can be created by using a preconfigured VM memory file stored at a particular location in the network; the location is included in a VM setup profile in the profile storage.

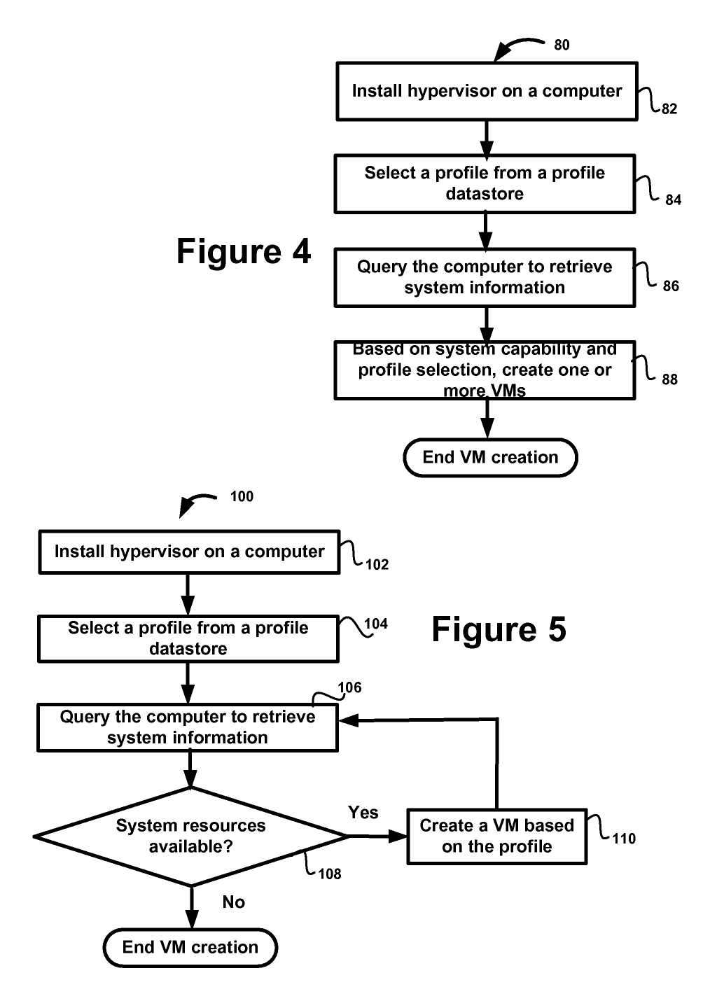

FIG. 4 illustrates another method of creating VMs 80. At step 82, a hypervisor is installed on a server. At step 84, a desirable VM setup profile is selected either via a user interface or through a script execution. The selected VM profile includes a type of operating system and software should be installed in a newly created VM. At step 86, the server is queried to retrieve a system configuration such as a type of the CPU, available RAM, available hard disk storage, etc. At step 88, a particular number of VMs are created based on the retrieved system configuration. A programming logic is provided to calculate a number of VMs a particular system configuration can optimally host. In one embodiment, this programming logic performs interpolation or extrapolation on a previously collected experimental data pertaining to running a number of VMs optimally in particular system configurations.

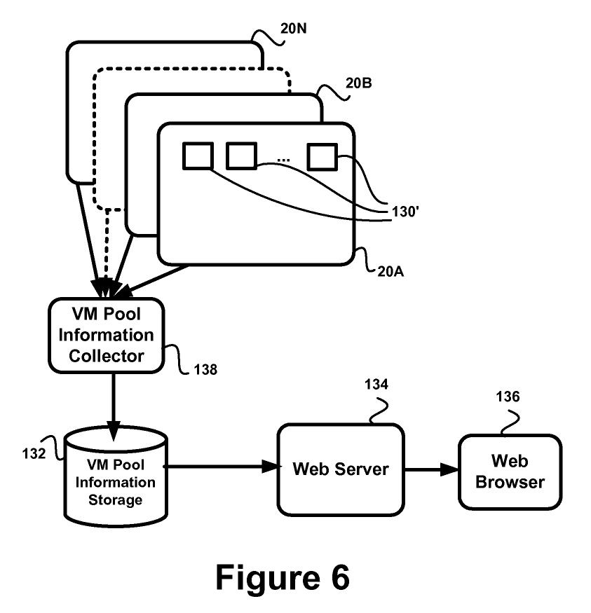

FIG. 5 illustrates yet another method of creating VMs 100. At step 102, a hypervisor is installed on a server. At step 104, a desirable VM setup profile is selected either via a user interface or through a script execution. The selected VM profile includes a type of operating system and software should be installed in a newly created VM. At step 106, the server is queried to retrieve a system configuration such as a type of the CPU, available RAM, available hard disk storage, etc. At a decision step 108, a programming logic determines if the current system or computing resources of the server can host one more VM of the selected type. The programming logic includes data as to how much computing resources of different types are typically consumed by a particular type of VM configuration. In one or more embodiments, the computing resources of a server include available random access memory, available hard disk space, available network bandwidth, and available processor power, etc. If yes, a VM of a selected type is created and then step 106 is performed again. At decision step 108, if a determination is made that the remaining system or computing resources cannot host another VM of the selected type, the process ends.

FIG. 6 illustrates a system for collecting VM pool information according to one or more embodiments. After a number of VMs 130′ are created, VM Pool Information Collector 138 collects identification and other relevant information such as the IP address, name, installed applications, installed operating system, etc. of these VMs being hosted on one or more 20A, 20B,20N. VM Pool Information Collector 138 stores a list of VMs being hosted in a virtualization landscape in VM Pool Information Storage 132. VM Pool Information Storage 132, in one embodiment, is a relational database system. In other embodiments, VM Pool Information Storage 132 can be any type of data storage so long as the information can be stored and retrieved using conventional data storage and retrieval methods (Example: file system, XML data store, etc.).

Still referring to FIG. 6, which illustrates a Web Server 134 in communication with VM Pool Information Storage 132 on one side and to Internet/Web Browser 136 on the other side. Web Server 134 hosts a self service user application to enable users to see a list of all or a subset of VMs in a virtualization landscape. On the consumer side, users or administrators can make use of this self-service application to select one or more VMs from the VM pool to reserve the selected VMs for their own use. In one embodiment, once one or more VMs are selected and reserved for a specific use, these VMs are removed from the VM pool. In one embodiment, a virtual blade server can be build by selecting and reserving a plurality of VMs and associating this group of VMs to a network switch. Term “virtual blade server” as used herein describes a blade server in which individual computer modules are made of virtual machines rather than convention computer hardware. It may be noted that in other embodiments, the self-service application may be hosted in any computer and can be accessed directly without a use of Web server 134 and/or the Internet.

In one or more embodiments, programming instructions for executing above described methods and systems are provided. The programming instructions are stored in a computer readable media.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

In addition, while described virtualization methods have generally assumed that virtual machines present interfaces consistent with a particular hardware system, persons of ordinary skill in the art will recognize that the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A method of creating a new virtual machine in a hypervisor server, the method comprising:
(a) selecting a virtual machine setup profile from a plurality of virtual machine setup profiles;
(b) retrieving a system information from the hypervisor server, wherein the system information includes available computing resources in the hypervisor server;
(c) determining if the available computing resources are sufficient to host the new virtual machine;
(d) calculating if the available computing resources are sufficient to host the new virtual machine, if the available resources are sufficient, creating a new virtual machine based on the virtual machine setup profile; and
(e) repeating steps (b) to (d) until the available computing resources become insufficient to host the new virtual machine based on the virtual machine setup profile.

2. The method as recited in claim 1, wherein the virtual machine setup profile includes an identification of an operating system that is to be installed in the new virtual machine.

3. The method as recited in claim 1, wherein the virtual machine setup profile includes an identification of a software application that is to be installed in the new virtual machine.

4. The method as recited in claim 1, wherein the virtual machine setup profile includes a path to a virtual machine memory file, wherein the hypervisor server creates the new virtual machine using the virtual machine memory file.

5. The method as recited in claim 1, wherein the available computing resources include available read only memory, available hard disk space, and processor power.

6. The method as recited in claim 1, wherein each of the plurality of virtual machine setup profiles includes requirements for read only memory, hard disk space, and processor power.

7. A method of creating a plurality of virtual machines in a hypervisor server, the method comprising:
selecting a virtual machine setup profile from a plurality of virtual machine setup profiles;
retrieving a system information from the hypervisor server, wherein the system information includes available computing resources in the hypervisor server;
calculating a number of the plurality of virtual machines that can be hosted in the hypervisor server based on the available computing resources; and
creating the number of the plurality of virtual machines in the hypervisor server.

8. The method as recited in claim 7, wherein the virtual machine setup profile includes an identification of an operating system that is to be installed in the new virtual machine.

9. The method as recited in claim 7, wherein the virtual machine setup profile includes an identification of a software application that is to be installed in the new virtual machine.

10. The method as recited in claim 7, wherein the virtual machine setup profile includes a path to a virtual machine memory file, wherein the hypervisor server creates the new virtual machine using the virtual machine memory file.

11. The method as recited in claim 7, wherein the available computing resources include available read only memory, available hard disk space, and processor power.

12. The method as recited in claim 7, wherein each of the plurality of virtual machine setup profiles includes requirements for read only memory, hard disk space, and processor power.

13. A computer readable media to store programming instructions for creating a new virtual machine in a hypervisor server, the computer readable media comprising:
programming instructions for (a) selecting a virtual machine setup profile from a plurality of virtual machine setup profiles;
programming instructions for (b) retrieving a system information from the hypervisor server, wherein the system information includes available computing resources in the hypervisor server;
programming instructions for (c) determining if the available computing resources are sufficient to host the new virtual machine;
programming instructions for determining (d) if the available computing resources are sufficient to host the new virtual machine, and if the available computing resources are sufficient, creating a new virtual machine based on the virtual machine setup profile; and
programming instructions for repeating steps (b) to (d) until the available computing resources become insufficient to host the new virtual machine based on the virtual machine setup profile.

14. The A computer readable media as recited in claim 13, further including programming instructions for retrieving from the virtual machine setup profile an identification of an operating system that is to be installed in the new virtual machine.

15. The method as recited in claim 13, further including programming instructions for retrieving from the virtual machine setup profile an identification of a software application that is to be installed in the new virtual machine.

16. The method as recited in claim 13, further including programming instructions for retrieving from the virtual machine setup profile includes a path to a virtual machine memory file, wherein the hypervisor server creates the new virtual machine using the virtual machine memory file.

17. The method as recited in claim 13, wherein the available computing resources include available read only memory, available hard disk space, and processor power.

18. The method as recited in claim 13, wherein each of the plurality of virtual machine setup profiles includes requirements for read only memory, hard disk space, and processor power.

19. A system for crating a virtual blade server, the system comprising:
a virtual machine (VM) pool information collector to retrieve a list of virtual machines from a hypervisor server;
a VM pool information storage in communication with the VM pool information collector to store the list of virtual machines; and
a Web server in communication with the VM pool information storage to host an application to display the list of virtual machines, wherein the application enables selection of a VM from the list of virtual machines to reserve the VM for a specific use.

20. The system as recited in claim 19, wherein the list of virtual machines includes at least one of IP addresses, names, installed operating system, and installed applications of each VM in the list of virtual machines.
